(19) United States
(12) Patent Application Publication
(10) Pub. No.: US 2014/0025523 A1
(43) Pub. Date: Jan. 23, 2014

(54) BIDDING APPICATION FOR PURCHASING ITEMS

(71) Applicants: Fay Arjomandi, Redwood City, CA (US); Volkmar Scharf-Katz, San Francisco, CA (US); Oleksiy Ignatyev, Belmont, CA (US)

(72) Inventors: Fay Arjomandi, Redwood City, CA (US); Volkmar Scharf-Katz, San Francisco, CA (US); Oleksiy Ignatyev, Belmont, CA (US)

(73) Assignee: VODAFONE IP LICENSING LIMITED, Newbury (GB)

(21) Appl. No.: 13/550,775

(22) Filed: Jul. 17, 2012

(51) Int. Cl. G06Q 30/08

(52) U.S. Cl. 705/26.3

(57) ABSTRACT

A bidding process between a computing device and a plurality of vendors to purchase a desired product. A desired product to be purchased during the bidding process is identified. A specified time window during which the bidding process will be performed is designated. The bidding process with a plurality of vendors who are able to provide the desired product for purchase based at least in part upon one or more profiles is initiated. First purchase information related to the desired product from a first vendor and second purchase information from a second vendor is received in real time during the specified time window. The purchase information is configured to be updated in real time. The purchase of the desired product from a selected one of the first or second vendor based on the first and second purchase information is finalized.

### BACKGROUND

Online retailing is growing in popularity and importance as customers increasing desire to make purchases over the Internet or other networks. In one common online purchase method, a merchant or other seller may place an item up for bid. Interested purchasers may then bid against each other on the item. Typically, the purchaser with the highest bid is able to purchase the item.

Another online purchase method allows a seller of a product to offer a price or other information to entice an interested purchaser to purchase the product from the seller instead of another seller. Typically, if the offer is favorable enough so that the purchaser is willing to pay the offered price, the purchase will occur.

However, neither of these methods allows for the interested purchaser to receive real time offers from multiple sellers who may desire to sell a product that the purchaser desires to purchase. In addition, these methods do not allow a particular seller to provide in real time a more favorable updated offer in response to offers the purchaser receives from other sellers to entice the purchaser to purchase the item from the particular seller.

### SUMMARY

Embodiments disclosed herein relate to a method and computer program product for selecting a desired product and initiating a bidding process between a computing device and a plurality of vendors to purchase the desired product. A desired product to be purchased during a bidding process is identified. A specified time window during which the bidding process will be performed is designated. The bidding process with a plurality of vendors who are able to provide the desired product for purchase based at least in part upon one or more profiles is initiated. First purchase information related to the desired product from a first vendor of the plurality of vendors is received in real time during the specified time window. The first purchase information is configured to be updated in real time during the specified time window. Second purchase information related to the desired product from a second vendor of the plurality of vendors is received in real time during the specified time window. The second purchase information is configured to be updated in real time during the specified time window. The purchase of the desired product from a selected one of the first or second vendor based on the first and second purchase information is finalized.

An embodiment disclosed herein relates to a computing device connected to a plurality of vendors that are able to sell a desired product. The device includes a processor, one or more physical storage medium and a bid engine configured to initiate and participate in a real time bid process with the plurality of vendors for purchasing the desired product. The bid engine includes a first module, a second module, a third module, a fourth module and a fifth module. The first module identifies a desired product for purchase. The second module identifies and connects with a plurality of vendors who offer to sell the desired product based on one or more profiles. The third module specifies a time window in which the bid process will occur. The fourth module receives, in real time, first purchase information related to the desired product from a first vendor of the plurality of vendors and second purchase information related to the desired product from a second vendor of the plurality of vendors. The fifth module finalizes the purchase of the desired product based on the first and second purchase information.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

To further clarify the advantages and features of the various embodiments of the invention, a more particular description will be rendered by reference to specific embodiments that are illustrated in the appended drawings. It is appreciated that these drawings depict only typical embodiments of the invention and are therefore not to be considered limiting of its scope. The various embodiments will be described and explained with additional specificity and detail through the use of the accompanying drawings in which:

FIG. 1 illustrates an embodiment of a system for performing a bidding process;

FIG. 2 illustrates an embodiment of a computing device and vendors of the system of FIG. 1;

FIG. 3 illustrates an alternative embodiment of a system for performing a bidding process; and

FIG. 4 illustrates a flow diagram of an embodiment of a method for selecting a desired product and initiating a bidding process with one or more vendors to purchase the desired product

### DETAILED DESCRIPTION

In the following detailed description, reference is made to the accompanying drawings, which form a part hereof. In the drawings, similar symbols typically identify similar components, unless context dictates otherwise. The embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein. It will also be understood that any reference to a first, second, etc. element (for example first purchase information) in the claims or in the detailed description, is not meant to imply numerical sequence, but is meant to distinguish one element from another unless explicitly noted as implying numerical sequence.

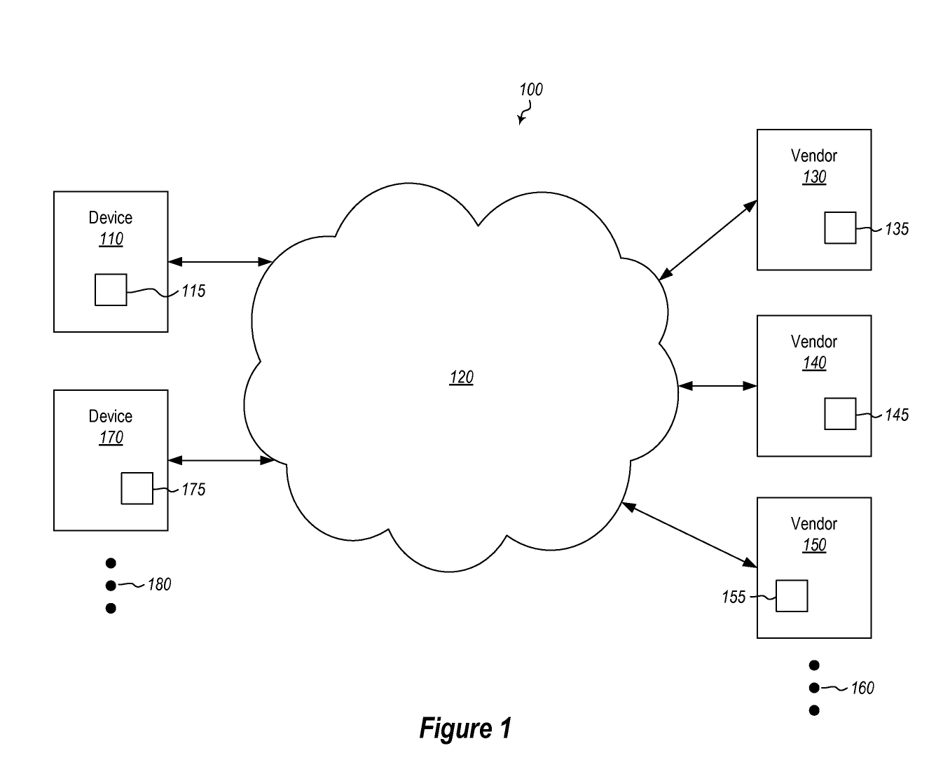

Several embodiments of respective aspects of the present disclosure are given below by way of example with reference to the accompanying figures. FIG. 1 is a schematic of an embodiment of a system 100. As illustrated, the system 100 includes a computing device 110. The computing device 110 may be any type of computing device that has processing resources or other resources that can perform at least a portion of a bidding process as will be explained in more detail to follow. Examples include, but at not limited to, desktop computers, laptop computers, tablet computers, server computers, mobile phones including cellular phone and smart phones, digital audio players, and PDAs. It will be appreciated that the embodiments disclosed herein are not limited by the type of the computing device 110.

The computing device 110 may be coupled to vendors 130, 140, 150, and potentially any number of additional vendors as illustrated by ellipses 160. The vendors 130, 140, 150 represent any entity that offers for sale various products and services or any combination thereof. Such products or services may include products or services 135, 145, and 155 that are offered for sale by vendors 130, 140, and 150 respectively. Accordingly, the vendors 130, 140, and 150 may be brick and mortar business such as malls, clothing stores, product stores, grocery stores, or any other type of physical location that sales products or services. The vendors 130, 140, and 150 may also be Internet or other computerized businesses or websites that sale products or services over a computer network without having a physical location. The vendors 130, 140, and 150 may also be a combination of a brick and mortar business and an Internet or other computerized business. The vendors 130, 140, and 150 may further be individual sellers. It will be appreciated that the embodiments disclosed herein are not limited by the type of entity of the vendors 130, 140, and 150.

As illustrated, the computing device 110 includes a bid engine or module 115. As will described in more detail to follow, the bid engine or module 115 may be configured to allow the computing device 110 to initiate and perform a bidding process for a desired product such as product 135, 145, or 155 of the vendors 130, 140, and 150.

The computing device 110 may be coupled to the vendors 130, 140, and 150 by a network 120. As shown in FIG. 1, computing device 110 and the vendors 130, 140, and 150 may communicate with each other bi-directionally over the network 120. The network 120 may be any network that is compatible with the computing device 110 and the vendors 130, 140, and 150 and may include, by way of example, satellite networks, 802.11 networks, personal computer networks (e.g., LAN, WAN), wireless networks (e.g., Bluetooth, WiFi), cellular networks, telephony networks (e.g., landline or PSTN), data networks, the Internet, or the like or any combination thereof. It will be appreciated that the embodiments disclosed herein are not limited by the type of network 120.

In some embodiments, the system 100 further includes a second computing device 170. The second computing device 170 may be any reasonable computing device such as those examples previously discussed in relation to computing device 110. The computing device 170 may include a bid engine 175 that operates in the same manner as bid engine 115. The computing device 170 may also be coupled to the vendors 130, 140, and 150 over the network 120. The ellipses 180 indicate that there may be any number of additional computing devices.

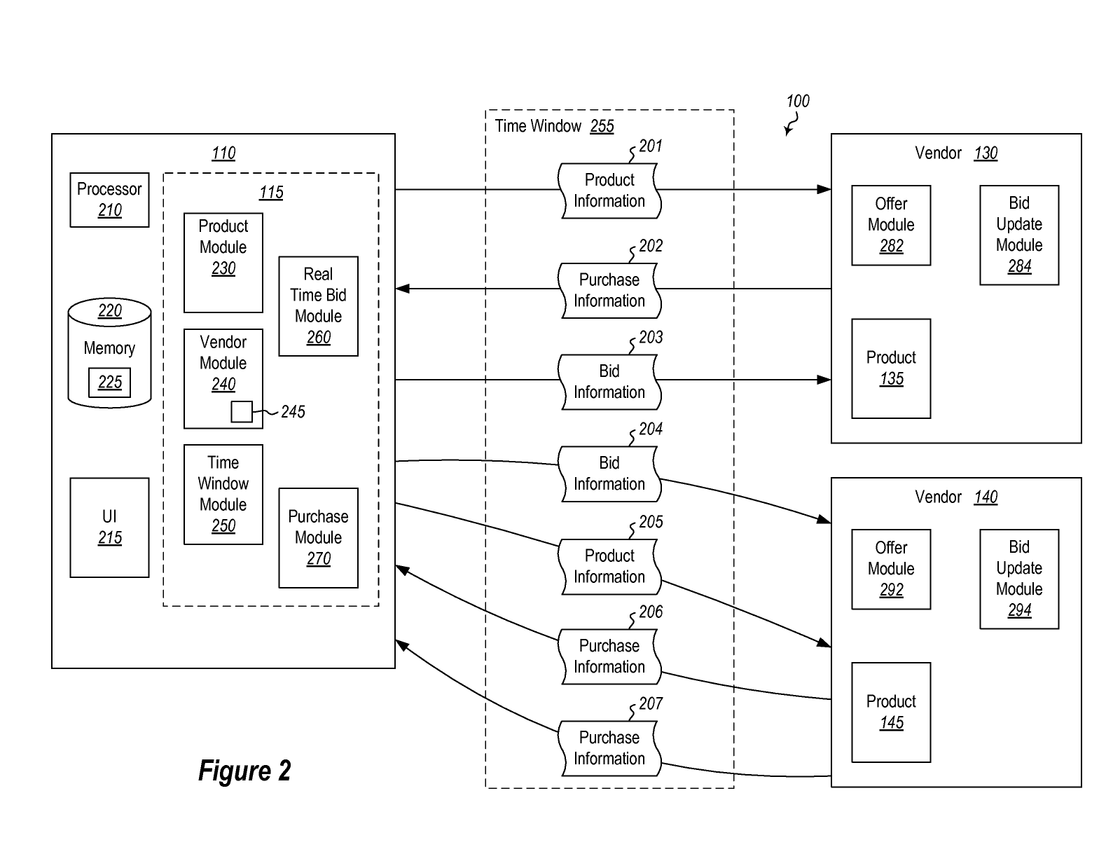

FIG. 2 illustrates an embodiment of the computing device 110, vendor 130, vendor 140 as well as a more detailed view of the system 100. In FIG. 2, the network 120 has been omitted so that the additional features of this figure may be seen more clearly. As shown, the computing device 110 includes various operational modules and databases that will be explained in more detail. Although not shown as being coupled, so as to not distract from the embodiments disclosed herein, it will be understood that the various operational modules and databases of the computing device 110 may be coupled to each other by any reasonable means such as a computer bus, other wiring, or wireless connection as circumstances warrant.

As shown, the computing device 110 includes a processor 210. The processor 210 may be any reasonable processor and in operation allows the computing device 110 to perform various operations. In some embodiments, the processor 210 may be accessed by the various operational modules of the computing device 110 to provide the modules processing resources. In other embodiments, the operational modules may have access to an alternative processor.

The computing device 110 also includes a memory or database 220. The memory 220 may be any type of reasonable non-volatile or volatile memory. Although the memory 220 is shown as being included within the computing device 110, in some embodiments the memory 220 may be external to the computing device 110 while being accessible to the computing device 110.

In one embodiment, the memory 220 may include or store profile information 225. In some embodiments, the profile information 225 may include static profile information about a purchaser who uses the computing device 110 to perform the bidding process as will be explained in more detail to follow. It will be appreciated that any reference to a purchaser made herein may refer to a purchaser who is an individual human user of the computing device 110 or may refer to a purchaser who is another computing system or other entity that uses computing device 110. The static profile information 225 may include demographic information about the purchaser such as age, gender, marriage status, family size, income, job, place of residence or any other personal information. In addition, the static profile information may include activities, sports, hobbies or the like that may be useful in determining types of products the purchaser may desire to purchase.

The computing device 110 may further include a user interface (UI) 215. The UI 215 may include a display, input device such as a keyboard, and any other element that may be used by the purchaser to interact with the computing device 110.

As previously discussed, the computing device 110 may include a bid engine 115 that is configured to initiate and perform a bidding process for purchasing a desired product from one of the vendors 130, 140, 150. In some embodiments, the bid engine 115 may be implemented in hardware, software, firmware, or any combination thereof. The bid engine 115 may include various modules as will now be explained. It will be appreciated that although the various modules of the bid engine 115 are shown as being separate, this is for ease of illustration only. In some embodiments, the various modules may be combined. In other embodiments, there may be more or less than the illustrated modules as circumstances warrant.

It will be appreciated that the operations described as being performed by a specific module of the bid engine 115 is for illustration only. Thus, any operation described as being performed by a specific module of the bid engine 115 may be performed by another module or combination of modules of the bid engine 115 in alternative embodiments. It will further be appreciated that any action or operation described as being performed by the bid engine 115 or one of the modules of the bid engine 115 may be performed in response to input received from a user (for example, a purchaser) of the computing device 110. It will be appreciated that a user may be a human user, another computing entity, or some other entity.

The bid engine 115 may include a product module 230. In operation, the product module 230 may allow the computing device 110 to identity desired products or services for purchase. In some embodiments, the product module 230 may allow a purchaser who is using computing device 110 to access or otherwise interact with published information about a desired product or service. For example, the published information may be advertisements or other information about a product found in a magazine, a news paper, a website, a television advertisement, printed product information published in a grocery store, mall, or any other retail store, or any other place where product information is published. In other embodiments, the purchaser may physically view, hear about, or read about the desired product or service.

In some embodiments, such as when the computing device 110 is a mobile device, the product module 230 (or other element of computing device 110) may include a sensor or the like that is configured to automatically identify a desired product or service. For example, the sensor may have access to a description of a desired product stored in memory 220 or stored elsewhere. When the sensor views such a product, for example on the Internet or while the computing device 110 is being carried into a retail store, the sensor will automatically identify the product as a desired product for purchase.

In some embodiments, once the desired product has been identified in the manner previously discussed or in some other manner, the product module 230 may receive purchaser input that initiates the bidding process to purchase the identified product. In other embodiments, once the desired product has been identified, either automatically or by receiving purchaser input to the computing device 110, the bidding process is automatically initiated by the bid engine 115.

The bid engine 115 may include a vendor module 240. In operation, the vendor module 240 is configured to identify or determine which of the vendors 130, 140, and 150 are able to provide the desired product. In some embodiments, this determination is at least partially based on one or more profiles. As previously discussed, the profiles may include the static profiles 225 previously discussed. As mentioned, the static profiles 225 are typically related to purchaser information that can be determined prior to the initiation of the bidding process as this information does not typically change quickly.

In addition, the vendor module 240 may be able to generate dynamic, real time profiles 245. The dynamic, real time profiles are typically related to real time attributes of the purchaser that may change relatively quickly during a given amount of time. For example, one profile 245 may be related to the real proximity of the purchaser to a location of a particular vendor. As will be appreciated, a purchaser may be more likely to purchase from a vendor who is within a reasonable distance from the real time location of the purchaser. This may be especially true when a specified time window 255 is implemented on the bidding process as will be described in more detail to follow.

Another dynamic, real time profile 245 may be related to a real time activity of the purchaser. For example, if the purchaser is playing a particular sport, is visiting a particular location such as a store or museum, or is currently driving or walking, such real time activities can provide information about what types of products the purchaser is likely to buy or how often they may buy the desired product. In addition, such real time activities may limit which vendors may be able to participate in the bidding process due to the specified time window 255.

A further dynamic, real time profile 245 may be related to a current classification of the purchaser. For example, if the purchaser could be classified in real time as a traveler from one city to another, then perhaps only vendors in the destination city would be potential participants in the bidding process. Likewise, if the purchaser in real time could be classified as a soccer mom who is taking her children to soccer practice, then this classification may indicate the types of products she is likely to purchase.

It will be appreciated that the dynamic, real time profiles 245 may include any type of detail or information that gives context to the real time attributes of the purchaser. Accordingly, the embodiments disclosed herein are not limited to any particular type of dynamic, real time profile.

As mentioned, the bid engine 115 may also designate a specified time window 255 during which the bidding process is to be performed. Accordingly, the big engine 115 may include a time window module 250. The time window module 250 is configured to allow the purchaser or some other entity to designate the time limit for the bidding process. In this way, the length of the bidding process may be kept to a reasonable length of time. It will be appreciated that the length of time of the bidding process may be different for different types of purchasers. For example, if a purchaser desires to purchase a food item to eat in a short time period, then the specified time period would be relatively short. On the other hand, if the purchaser where traveling to a different city to make a purchase, then perhaps the specified time window 255 would be relatively long as there may be a long time for the purchaser to reach the different city.

In an embodiment illustrated in FIG. 2, the bid process may be initiated by the product module 230 or some other module of computing system 115 providing product information 201 to vendor 130 and product information 205 to vendor 140. In the illustrated embodiment, the vendors 130 and 140 both are able to provide a desired product 135 and 145, which is the same product in this embodiment. As described above, the process is initiated with vendors 130 and 140 based at least in part upon the profiles 225 and/or 245. That is, the profiles 225 and/or 245 help determine that the vendors 130 and 140 are within a certain proximity, location or area of interest that will allow the vendors 130 and 140 to provide the desired products 135 and 145 to the purchaser.

The product information 201 and 205 may include a request to purchase the desired product 135 and 145. Further, the product information 201 and 205 may include at least some of the profiles 225 and/or 245; particularly those profiles that would help the vendors 130 and 140 determine a suitable price for the desired product 135 and 145 and will be explained. The product information 201 and 205 may also indicate the length of the specified time window 255 so that the vendors 130 and 140 know how long the bidding process will be.

As illustrated, the product information 201 is received by an offer module 282 of the vendor 130. The offer module 282 may analyze the product information 201 and determine an offer to make to the bid engine 115. As mentioned, the offer module may utilize at least some of the profiles 225 and/or 245 when determining an offer to make. For example, in one embodiment, the offer module 282 may determine that the profile information of the purchaser would indicate that the purchaser is likely to be a repeat customer. In that case, the vendor 130 may make a lower priced offer to ensure future sales. For instances, if the vendor 130 were a wine vendor and the profiles 225 and/or 245 indicated that the purchaser was someone who bought large amounts of wine, the vendor 130 may base their offer to ensure that the purchaser would buy future wine from vendor 130.

In another embodiment, the real time location of the purchaser may be near to an outlet of the vendor 130 that includes a surplus of the desired product. In that case, the vendor 130 may offer a lower price to move the product. Likewise, if the purchaser is located in an area where the desired product is in high demand, the vendor 130 may only be willing to make a higher offer.

In further embodiments, the real time activities or classifications of the purchaser may used by the purchase module 282 to determine a suitable offer. It will be appreciated that any of the profiles 225 and/or 245 may be used to determine a suitable offer.

Once a suitable offer has been determined, the offer module 282 may provide purchase information 202 to a real time bid module 260 of the bid engine 115. The purchase information 202 may include information about the offer the vendor 130 is willing to make to cause the purchaser to purchase the desired product 135. For example, the purchase information 202 may include a purchase price that can be used to purchase the desired product 135. The purchase information 202 may also be a coupon or a voucher that allow the purchaser 130 to purchase the desired product 135 for a reduced price. It will be appreciated that the purchase information 202 may be any information designed to cause the purchaser to choose the vendor 130 as the source of the desired product.

The product information 205 is received by an offer module of the vendor 140. The offer module 292 may analyze the product information 205 and determine an offer to make to the bid engine 115. The offer module 292 may utilize at least some of the profiles 225 and/or 245 when determining what offer to make in the manner previously described in relation to offer module 282.

Once a suitable offer has been determined, the offer module 292 may provide purchase information 206 to a real time bid module 260 of the bid engine 115. The purchase information 206 may include information about the offer the vendor 140 is willing to make to cause the purchaser to purchase the desired product 145. The purchase information 206 may include the same information as the purchase information 202 and thus need not described in further detail.

The real time bid module 260 receives the purchase information 202 and 206 from the vendors 130 and 140. The real time bid module 260 then provides, in real time, bid information 203 to vendor 130 and bid information 204 to vendor 140. The bid information 203 includes the purchase information 206 provided by vendor 140 and the bid information 204 includes the purchase information 202 provided by the vendor 130. In this way, the vendors 130 and 140 are able in real time to view the offers being made by the other vendor. In some embodiments, the vendors 130 and 140 may provide the purchase information to each other directly or through a third party that does not include the computing device 110. In other embodiments, the bid information 203 and/or 204 may also include a counter offer from the bid engine 115. In this way, the vendors 130 and 140 are able in real time to receive updated information about how much the purchaser is willing to pay or if the purchase information provided by the vendors 130 and 140 contains an offer that is not acceptable to the purchaser.

As illustrated, the vendor 130 includes an update module 284 and the vendor 140 includes an update module 294. In operation, the update modules 284 and 294 may allow the vendor 130 and the vendor 140 to provide real time updates to the purchase information 202 and 206 respectively. In this way, vendors 130 and 140 are able in real time to react to the offer being provided by the other vendor. Accordingly, the vendors 130 and 140 may provide updated offers to the bid engine 115 during the specified time window 255.

In one embodiment, the vendor 140 may predetermine to beat any offer made by the vendor 130. For example, the vendor 130 may be a large grocery store chain that provides purchase information 202 that offers to discount the desired product 135 by a discount level X. The vendor 140 may be a small grocery store that desires to provide a better offer. In such embodiment, the offer module 292 may provide purchase information 207 to the real time bid module 260. The purchase information 207 may include an offer that is always Y % better than the discount level X. In addition, the purchase information 207 may cause the purchase information 206 to adjust to the offer specified by the purchase information 207. Accordingly, the vendor 140 is able to present an offer that will be more favorable than any updated offer provided by the vendor 130.

The real time bid module 260 may utilize the UI 215 to show a purchaser using the computing device 110 of the real time offers contained in purchase information 202 and 206 (and perhaps 207) from the vendors 130 and 140. In this way, the purchaser is able in real time to see the latest offers received from the vendors 130 and 140.

At the conclusion of the specified time window 255, the bid engine 115 is configured to no longer receive and accept any updated product information 202 or 206. The purchaser is then able to purchase the desired product 135 or the desired product 145 from the vendor 130 or 140 based on which offer was the best or which offer was selected by the purchaser.

Accordingly, the bid engine may include a purchase module 270. In operation, the purchase module 270 may finalize the purchase between the vendor who provides the selected offer and product and the purchaser. In one embodiment, the purchase module 270 selects the vendor 130 or the vendor 140 based on the purchase information 202 and 206. That is, the purchase module 270 may select the vendor who has provided the most favorable offer to the bid engine 115.

In one embodiment, finalizing the purchase of the desired product may also include agreeing upon a form of payment acceptable to the purchaser and the vendor selected to provide the desired product. For example, the acceptable form of payment may be a credit card, cash, a check, PayPal account payment or any other recognizable form of payment. The acceptable form of payment may require the purchaser to physically deliver the payment to the vendor or it may require mailing the payment or electronically providing the payment. It will be appreciated that the embodiments disclosed herein are not limited by the acceptable form of payment.

In addition, finalizing the purchase of the desired product may include agreeing upon an acceptable form of providing or delivering the desired product from the selected vendor to the purchaser. For example, the acceptable form of providing the product may be shipping the product to the purchaser over any reasonable means such as government mail or private courier. The acceptable form of providing the product may also be having the purchaser pick up the desired product. If the desired product is a service, then acceptable form of providing the product may be having the service performed.

Returning to FIG. 1, as previously described the system 100 may include the computing device 170 in addition to the computing device 110. In one embodiment, the bidding process may include the computing device 170 in addition to the computing device 110 and vendors 130 and 140 as previously described. In such embodiments, the vendors 130 and 140 may send real time purchase information to the bid engine 115 and the bid engine 175 as previously discussed. However, in the embodiment the computing devices 115 and 175 may also provide information to the vendors 130 and 140 that specifies what price range they are willing to pay for the desired product.

For example, in the embodiment the computing device 170 may provide the information to the vendors 130 and 140. The computing device 110 may in real time view or otherwise access the price range indicated by the computing device 170. The computing device 110 may then provide information to the vendors 130 and 140 that specifies a price range that is more favorable than that of the computing device 170. In this way, the embodiments disclosed herein contemplate a bid process including multiple purchasers using multiple computing devices and multiple vendors.

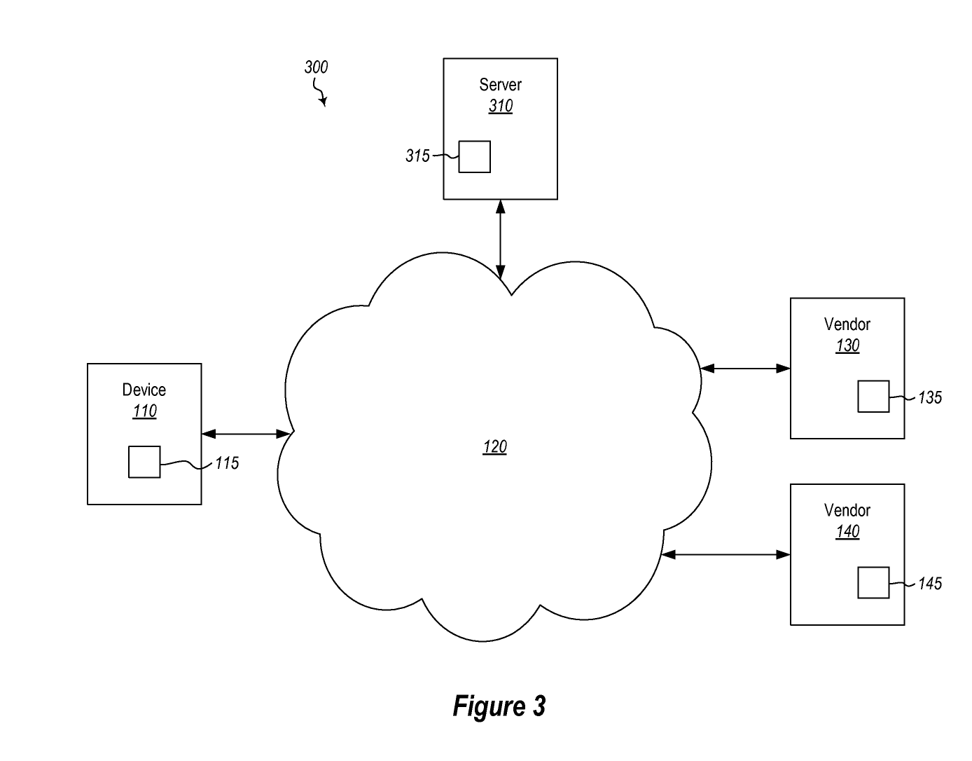

Attention is now given to FIG. 3, which illustrates a system 300. The system 300 is similar to the system 100 and similar elements will not be described. As illustrated, the system 300 includes a server computing system 310 that includes a bid engine 315. The server 300 may be controlled by an entity such as a telecommunication network provider or other like entity. It will be appreciated that although not illustrated, the system 300 may include computing devices 170 and 180 and vendors 150 and 160.

In one embodiment, the bid engine 315 may perform all the functionality described in relation to bid engine 115. In such embodiments, the bid engine 315 may receive input from the computing device 110 and the vendors 130 and 140 when performing the functionality of bid engine 115 previously described. In this way, the sever 310 and the bid engine 315 act as an intermediary between the computing device 110 and the vendors 130 and 140.

In another embodiment, at least some of the functionality of the bid engine 115 previously described may be handled by the bid engine 315 with the remaining functionality being performed by the bid engine 115. For example, the product module 220 and the other functionality of identifying a desired product may remain on the computing device 110 as this computing device is likely controlled by the purchaser. However, the remaining functionality of the bid engine 115, or some fraction of the remaining functionality, previously described may be performed by the bid engine 315. In the embodiment, the bid engine 315 may also act as an intermediary between the computing device 110 and the vendors 130 and 140. It will be appreciated, however, the bidding process previously described would still function the same. In addition, a purchaser using the computing device 110 would not notice that some of the functionality was performed at the server 315.

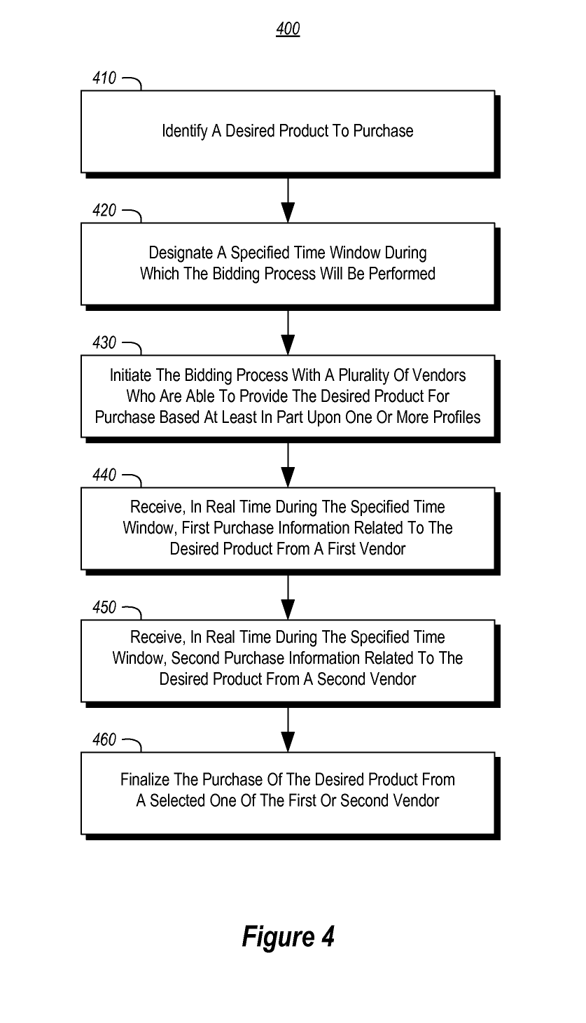

FIG. 4 is a flow diagram of an embodiment of a method 400 for selecting a desired product and initiating a bidding process with one or more vendors to purchase the desired product. In the illustrated embodiment, the method 400, and other methods and processes described herein, set forth various functional blocks or actions that may be described as processing steps, functional operations, events and/or acts, etc., which may be performed by hardware, software, and/or firmware of the elements of systems 100 and/or 300. The method 400 includes one or more operations as illustrated by acts 410, 420, 430, 440, 450 and/or 460.

The method 400 includes an act 410 of identifying a desired product to be purchased during a bidding process. For example, in one embodiment the bid engine 115 may identify the desired product 135 sold by the vendor 130 and the desired product 145 sold by the vendor 140 for purchase during the bidding process as previously described.

The method 400 includes an act 420 of designating a specified time window during which the bidding process will be performed. For example, in one embodiment the bid engine 115 may specify a time window 255 during which the bid process will be performed as previously described.

The method 400 includes an act 430 of initiating the bidding process with a plurality of vendors who are able to provide the desired product for purchase based at least in part upon one or more profiles. For example, in one embodiment the bid engine 115 may initiate the bid process with the vendor 130 and the vendor 140 after it is determined that these vendors are able to provide the desired product as previously described. One or more of the static profiles 225 and/or the real time, dynamic profiles 245 may be used to determine which of the vendors may provide the desired product. The bid engine 115 may provide product information 201 and 205 to the vendors 130 and 140 to initiate the bidding process as previously described.

The method 400 includes an act 440 of receiving, in real time during the specified time window, first purchase information related to the desired product from a first vendor of the plurality of vendors, the first purchase information being configured to be updated in real time during the specified time window. For example, in one embodiment the bid engine 115 receives purchase information 202 in real time from the vendor 130 during the specified time window 255. The purchase information 202 may include any information such as offer price, a coupon or voucher or the like that is designed to entice the purchaser to purchase the desired product 135 as previously described. The purchase information 202 may be influenced by the static profiles 225 and/or the real time, dynamic profiles 245 as previously described. The purchase information 202 may be updated in real time in the manner previously described.

The method 400 includes an act 450 of receiving, in real time during the specified time window, second purchase information related to the desired product from a second vendor of the plurality of vendors, the second purchase information being configured to be updated in real time during the specified time window. For example, in one embodiment the bid engine 115 receives purchase information 206 in real time from the vendor 140 during the specified time window 255. The purchase information 206 may include any information such as offer price, a coupon or voucher or the like that is designed to entice the purchaser to purchase the desired product 145 as previously described. The purchase information 206 may be influenced by the static profiles 225 and/or the real time, dynamic profiles 245 as previously described. The purchase information 206 may be updated in real time in the manner previously described.

The method 400 includes an act 460 of finalizing the purchase of the desired product from a selected one of the first or second vendor. For example, in one embodiment the bid engine 115, at the expiration of the specified time window 255, finalizes the purchase of the desired product 135 or 145 by selecting one of the products to purchase as previously described. Finalizing the purchase of the desired product may also include determining an acceptable form of payment for the product and/or determining an acceptable form of delivery of the desired product.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical non-transitory storage media. Computer-readable media that carry computer-executable instructions are transmission media. Thus, by way of example, and not limitation, embodiments of the invention can comprise at least two distinctly different kinds of computer-readable media: physical non-transitory storage media and transmission media.

Physical non-transitory storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to physical storage media (or vice versa). For example, computer-executable instructions or data structures received over a network or data link can be buffered in RAM within a network interface module (e.g., a “NIC”), and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a system including a computing device and a plurality of vendors connected to the device, a method for selecting a desired product and initiating a bidding process with the plurality of vendors to purchase the desired product, the method comprising:
identifying at the device a desired product to purchase during a bidding process;
designating a specified time window during which the bidding process will be performed;
initiating the bidding process with a plurality of vendors who are able to provide the desired product for purchase based at least in part upon one or more profiles;
receiving, in real time during the specified time window, first purchase information related to the desired product from a first vendor of the plurality of vendors, the first purchase information being configured to be updated in real time during the specified time window;
receiving, in real time during the specified time window, second purchase information related to the desired product from a second vendor of the plurality of vendors, the second purchase information being configured to be updated in real time during the specified time window; and
finalizing the purchase of the desired product from a selected one of the first or second vendor based on the first and second purchase information.

2. The method of claim 1, wherein updating the second purchase information in real time during the specified time window comprises:
receiving, in real time during the specified time window, third purchase information related to the desired product from the second vendor, wherein the third purchase information is an adjustment of the second purchase information, the second purchase information being adjusted to the third purchase information so as to represent a more favorable offer to a purchaser than the first purchase information received from the first vendor.

3. The method of claim 1, wherein at the expiration of the specified time window the first and second purchase information may no longer be updated; and
wherein the purchase of the desired product is finalized at the expiration of the specified time window.

4. The method of claim 1, wherein the first and second purchase information comprises one or more of:
a purchase price of the desired product;
a coupon;
a voucher; and
other information designed to cause a purchaser to choose the first or second vendor as the source of the desired product.

5. The method of claim 1, wherein the one or more profiles comprises one or more of:
demographic information of a purchaser;
real time proximity to the first and second vendor;
a real time action of the purchaser; or
a real time classification of the purchaser.

6. The method of claim 1, wherein finalizing the purchase of the desired product comprises:
agreeing upon a form of payment acceptable to a purchaser and the one of the first and second vendor selected to provide the desired product; and
agreeing upon an acceptable form of providing the purchased desired product from the one of the first and second vendor selected to provide the desired product to the purchaser.

7. The method of claim 1, wherein identifying a desired product to purchase comprises one of:
receiving purchaser input that selects the desired product; or
automatically selecting the desired product.

8. The method of claim 1, further comprising:
accessing first information provided by a second device, the first information specifying a purchase price that a user of the second device will pay to purchase the desired product; and
providing second information to one or both of the first and second vendors, the second bid information specifying a purchase price that is more favorable than the purchase price of the first information.

9. A computer program product for use in a system including a computing device and a plurality of vendors connected to the user device, the computer program product comprising one or more non-transitory computer-readable media having stored thereon computer-executable instructions that, when executed by a processor, cause the computing device to perform a method for selecting a desired product and initiating a bidding process with the plurality of vendors to purchase the desired product, the method comprising:
receiving input identifying a desired product to purchase during a bidding process;
designating a specified time window during which the bidding process will be performed;
initiating the biding process with a plurality of vendors who are able to provide the desired product for purchase based at least in part upon one or more profiles;
receiving, in real time during the specified time window, first purchase information related to the desired product from a first vendor of the plurality of vendors, the first purchase information being configured to be updated in real time during the specified time window;
receiving, in real time during the specified time window, second purchase information related to the desired product from a second vendor of the plurality of vendors, the second purchase information being configured to be updated in real time during the specified time window;
receiving input that selects which of the first or second vendor the desired product will be purchased from; and
receiving input to finalize the purchase of the desired product based on the first and second purchase information.

10. The computer program product of claim 9, wherein updating the second purchase information in real time during the specified time window comprises:
receiving, in real time during the specified time window, third purchase information related to the desired product from the second vendor, wherein the third purchase information is an adjustment of the second purchase information, the second purchase information being adjusted to the third purchase information so as to represent a more favorable offer to a purchaser than the first purchase information received from the first vendor.

11. The computer program product of claim 9, wherein at the expiration of the specified time window the first and second purchase information may no longer be updated; and
wherein the purchase of the desired product is finalized at the expiration of the specified time window.

12. The computer program product of claim 9, wherein the first and second purchase information comprises one or more of:
a purchase price of the desired product;
a coupon;
a voucher; and
other information designed to cause a purchaser to choose the first or second vendor as the source of the desired product.

13. The computer program product of claim 9, wherein the one or more profiles comprises one or more of:
demographic information of a purchaser;
real time proximity to the first and second vendor;
a real time action of the purchaser; or
a real time classification of the purchaser.

14. The computer program product of claim 9, wherein receiving input to finalize the purchase of the desired product comprises:
agreeing upon a form of payment acceptable to a purchaser and the one of the first and second vendor selected to provide the desired product; and
agreeing upon a form of providing the purchased desired product from the one of the first and second vendor selected to provide the desired product to the purchaser.

15. The computer program product of claim 9, wherein receiving input identifying a desired product to purchase comprises one of:
receiving user input that selects the desired product; or
automatically selecting the desired product.

16. A device connected to a plurality of vendors that are able to sell a desired product, the device comprising:
a processor;
one or more physical storage medium; and
a bid engine configured to initiate and participate in a real time bid process with the plurality of vendors for purchasing the desired product; the bid engine comprising:
a first module configured to identify a desired product for purchase;
a second module configured to identify and connect with a plurality of vendors who offer to sell the desired product, the identification at least partially based on one or more profiles;
a third module configured to specify a time window in which the bid process will occur;
a fourth module configured to receive, in real time, first purchase information related to the desired product from a first vendor of the plurality of vendors and to receive second purchase information related to the desired product from a second vendor of the plurality of vendors; and
a fifth module configured to finalize the purchase of the desired product based on the first and second purchase information.

17. The device of claim of claim 16, wherein the bid engine is located on a single computing device.

18. The device of claim of claim 16, wherein the herein the bid engine is located on more than one computing device.

19. The device of claim of claim 16, wherein the first and second purchase information comprises one or more of:
a purchase price of the desired product;
a coupon;
a voucher; and
other information designed to cause a purchaser to choose the first or second vendor as the source of the desired product.

20. The device of claim of claim 16, wherein the one or more profiles comprises one or more of:
demographic information of a purchaser;
real time proximity to the first and second vendor;
a real time action of the purchaser; or
a real time classification of the purchaser.
